(19) United States
(12) Patent Application Publication
(10) Pub. No.: US 2018/0349287 A1
(43) Pub. Date: Dec. 6, 2018

(54) Persistent Storage Device Information Cache

(71) Applicant: Dell Products L.P., Round Rock, TX (US)

(72) Inventor: Lip Vui Kan, Singapore (SG)

(73) Assignee: Dell Products L.P., Round Rock, TX (US)

(21) Appl. No.: 15/612,449

(22) Filed: Jun. 2, 2017

(51) Int. Cl. G06F 12/1009

(52) U.S. Cl. CPC G06F 12/1009; G06F 2212/65; G06F 2212/1041

(57) ABSTRACT

A persistent storage device, such as a solid state drive, repurposes translation table memory, such as RAM integrated in a SSD controller that stores an FTL table, to pre-fetch and cache data associated with selected logical addresses, such as LBAs that are historically referenced at a higher rate. Repurposed FTL table memory to serve as a cache for frequently used persistent information improves storage device response time.

### CROSS REFERENCE TO RELATED APPLICATION

U.S. patent application Ser. No. 15/273,573, entitled “System and Method for Adaptive Optimization for Performance in Solid State Drives Based on Segment Access Frequency” by inventors Lip Vui Kan and Young Hwan Jang, Attorney Docket No. DC-107304.01, filed on Sep. 22, 2016, describes exemplary methods and systems and is incorporated by reference in its entirety.

### BACKGROUND OF THE INVENTION

### Field of the Invention

The present invention relates in general to the field of server information handling system management, and more particularly to a server information handling system NFC ticket management and fault storage.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally process information held in persistent storage using instructions also stored in persistent storage. Generally, at power up of an information handling system, embedded code loads onto the processor to “boot” an operating system by retrieving the operating system from the persistent storage device, such as a solid state drive (SSD) or hard disk drive (HDD), to random access memory (RAM) interfaced with the processor. Executing instructions from RAM typically provides more rapid information transfers than executing instructions from persistent storage, such as flash memory. However, since RAM consumes power when storing information, long term storage of information in RAM is not typically cost effective compared with persistent storage devices that store information using flash memory, magnetic disks, magnet tapes, laser discs and other non-volatile memory media that do not consume power to store the information. Once the operating system executes on the processor from RAM, other applications that run over the operating system are retrieved from persistent storage to RAM for execution. Similarly, information processed by the operating system and applications, such as documents and images, are retrieved to RAM from persistent memory for modification and then stored again in persistent memory for long term storage during power down of the information handling system.

One difficulty with executing applications and processing information from persistent storage is that retrieval and writing of instructions and information from and to persistent storage takes longer than similar operations in RAM. For example, a user who initiates an application from an SSD will typically experience some lag as the application is retrieved from the SSD into RAM. Similar lag typically occurs during writes of information from RAM to the SSD. A typical NAND read operation can take a magnitude order of 1000 compared to read operations from DRAM so that host media command completion time is in the range of milliseconds. Another difficulty with flash memory, such as NAND found in many SSDs, is that with writes over time the flash memory wears until the memory becomes unusable. In order to maximize the useful life of flash memory, storage devices often implement wear leveling algorithms that attempt to even out the program/erase cycles of the flash memory across the storage device. A typical wear leveling algorithm uses address indirection to coordinate use of different memory addresses over time.

In order to improve the speed of read and write operations while managing wear leveling, persistent storage devices generally include a controller that executes embedded code to interface an information handling system processor with the storage device's non-volatile memory. The information handling system operating system references stored information by using a Logical Block Address (LBA), which the storage device controller translates to a physical address. Referencing an LBA allows the operating system to track information by a constant address while shifting the work of translation to physical addresses to specialized hardware and embedded code of the storage device controller. The storage device controller is then free to perform wear leveling by adapting logical addresses to physical addresses that change over time. A flash translation table (FTL) managed by the storage device controller tracks the relationship between logical and physical memory addresses.

Generally, storage device controllers include a RAM buffer that stores the FTL table for rapid address lookup by a processor integrated in the storage device controller. On power up of the storage device, the storage device controller retrieves the FTL table from non-volatile memory to RAM and then responds to operating system LBA interactions by looking up physical addresses in the FTL. As a general rule, 1 MB of RAM indexes physical addresses for 1 GB of non-volatile memory. Thus, as an example, a 512 MB RAM FTL buffer supports a 512 GB SSD.

One recent innovation by Dell Inc. for improved persistent storage device performance is “System and Method for Adaptive Optimization for Performance in Solid State Drives Based on Segment Access Frequency,” by Lip Vui Kan and Young Hwan Jang, application Ser. No. 15/273,573, Docket Number DC-107304, filed on Sep. 22, 2016, which is incorporated herein as if fully set forth. This innovation reduces the size of RAM buffer for storing an FTL table by limiting the number of LBAs in the FTL table that are loaded to RAM, thus reducing the size of RAM used by the storage device controller.

### SUMMARY OF THE INVENTION

Therefore, a need has arisen for a system and method which caches information at a storage device controller.

In accordance with the present invention, a system and method are provided which substantially reduce the disadvantages and problems associated with previous methods and systems for interacting with persistent storage devices. A storage device controller selectively loads all or only a portion of a translation table in a translation table memory. If only a portion of the translation table is loaded, the unused translation table memory is repurposed to cache information stored in the persistent storage device.

More specifically, a host information handling system host executes an operating system to manage information, such as with reads and writes to a persistent storage device. The host communicates requests to a persistent storage device controller using logical block addresses. The persistent storage device controller translates the logical block address to a physical address of persistent storage to read or write information at the physical address location. In an example embodiment, the persistent storage device is a solid state drive having NAND flash memory that the storage device controller wear levels by reference to a flash translation layer table stored in a DRAM integrated with the storage controller. A cache manager selectively loads all or only a portion of the flash translation table to the DRAM based upon predetermined conditions, such as an analysis that only the selected portions of logical block addresses will be referenced by the host. If only a portion of the translation table is loaded, then unused DRAM is repurposed to cache information related to selected of the logical block addresses in the DRAM. If the host references a logical block address that has information cached in the translation table memory, then the storage controller responds using the cached information. Thus, for example, a read request by an operating system to a logical block address having cached information stored in the repurposed translation table memory will receive a more rapid response from the storage controller by looking up the information in the translation table memory cache instead of retrieving the information from flash memory of the persistent storage device.

The present invention provides a number of important technical advantages. One example of an important technical advantage is that a storage device controller translation table memory is selectively repurposed to provide a more rapid response to reads from persistent storage. When only a portion of the translation table is loaded to a translation table memory, unused memory space in the translation table memory is repurposed to cache information stored in the persistent storage device. The translation table memory provides a rapid response to requests for information from the persistent storage device when the information is cached. Selection of commonly referenced information to store in the cache based upon historical references focuses a rapid cache response to information more frequently requested by a host device. Predictive algorithms in the storage device controller or at the host, such as the operating system, optimize selection of information for caching in the translation memory.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a persistent storage device;

FIG. 2 depicts a block diagram of a solid state drive controller having translation table memory repurposed for cache of stored information;

FIG. 3 depicts a flow diagram of a process for selectively caching information to a translation table memory;

FIG. 4 depicts a flow diagram of a process for selecting information to cache to a translation table memory;

FIG. 5 depicts a flow diagram of a process for reading and writing information at a persistent storage device having translation table memory repurposed to cache stored information; and

FIG. 6 depicts an example of a flash translation layer table caching information for selected logical addresses.

### DETAILED DESCRIPTION

An information handling system persistent storage device selectively caches information in translation table memory. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

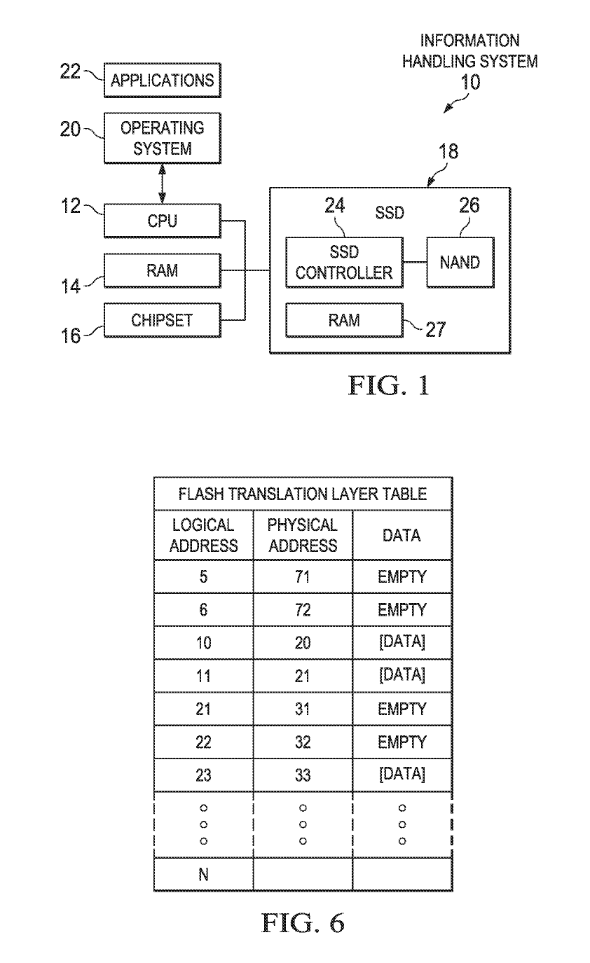

Referring now to FIG. 1, a block diagram depicts an information handling system 10 having a persistent storage device 18. The simplified block diagram illustrates information handling system 10 acting as a host device that retrieves and writes information to persistent storage. A central processing unit (CPU) 12 executes instructions to process information. Random access memory (RAM) 14, such as DRAM modules, stores the instructions and information in cooperation with CPU 12. A chipset 16 includes a variety of processing components and embedded code to manage interactions of CPU 12 with external devices on a physical level. For example, chipset 16 may include graphics processing components that generate visual images from the information for presentation at a display, memory controllers for accessing memory devices, an embedded controller for managing power and input/output (I/O) devices, wireless components for wireless communication, networking components for network communications, etc. An operating system 20 executes on CPU 12 to manage component interactions on a logical level. For example, operating system 20 provides programming interfaces that applications 22 use to access physical devices. For instance, operating system 20 supports interactions with persistent storage device 18 through logical block addresses so that an end user can execute applications stored in persistent memory and retrieve files with content used by the applications.

In an example embodiment, on power up CPU 12 retrieves and executes operating system 20 from persistent storage in a bootstrapping process. Operating system 20 includes instructions and information stored in persistent memory that is retrieved to RAM 14 for execution by CPU 12. The example persistent storage device is a solid state drive 18 (SSD) that includes an integrated controller 24, NAND flash memory modules 26 and random access memory (RAM) 27. SSD controller 24 receives logical block address (LBA) requests from operating system 20, converts the LBAs to physical addresses of NAND 26, applies the requested action at the physical address associated with the LBA, and responds to operating system 20 with a LBA. RAM 27 supports SSD controller 24 by providing a fast response buffer to store information used by SSD controller 24. In one embodiment, RAM 27 may actually have separate physical memories that support separate tasks, such as buffering information for transfer to and from NAND 26 and storing a translation table that maps NAND locations to operating system memory requests. In the example embodiment, RAM 27 integrates with SSD 18; however in alternative embodiments, some buffer functions may be supported with system RAM 14. In the example embodiment, solid state drive 18 includes a wear leveling algorithm that spreads program/erase (P/E) cycles across NAND devices to promote the life span of the flash memory over time. Wear leveling is accomplished at SSD controller 24 so that operating system 20 interacts with information through LBAs while the actual physical storage location of information can change within the persistent storage. A dedicated portion of RAM 27 stores a translation table that maps operating system LBA requests to physical NAND addresses. In alternative embodiments, other types of persistent storage devices may be used, with or without wear leveling.

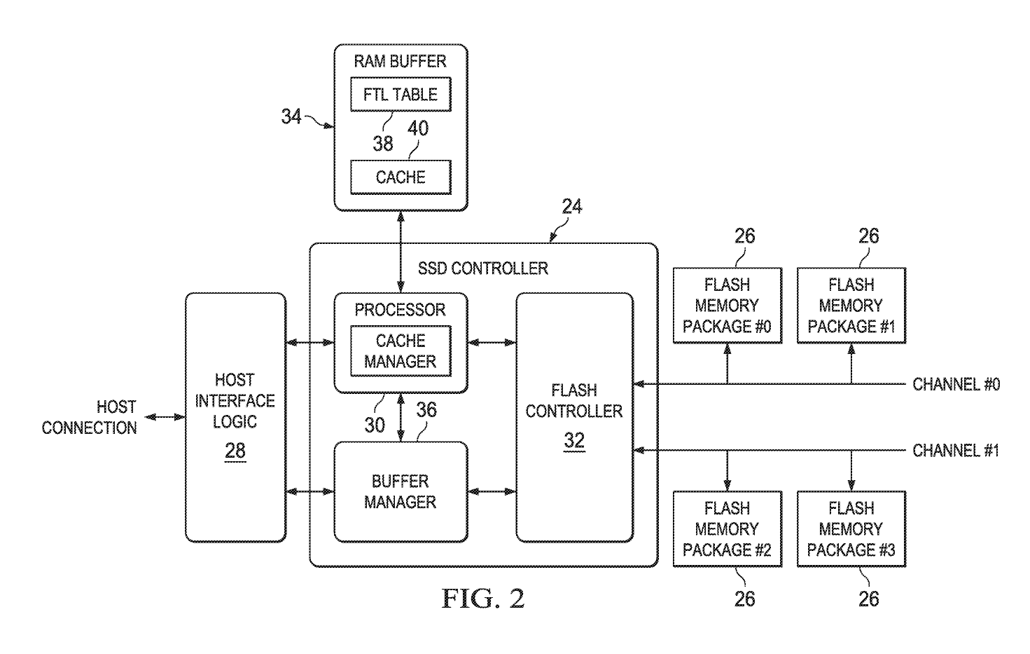

Referring now to FIG. 2, a block diagram depicts a solid state drive controller 24 having translation table memory 34 repurposed for cache of stored information. In the example embodiment, host interface logic 28 communicates with a host device, such as an information handling system operating system, to receive read and write requests for flash memory packages 26. As host device storage requests arrive with references to LBAs, a processor 30 converts the LBAs to physical addresses that a flash controller 32 uses to access memory locations that store information associated with the LBAs. A buffer manager 36 interfaced with flash controller 32 manages information transfers out of host interface logic 28 while processor 30 ensures that response to LBA requests have appropriate address information.

In order to translate LBAs to physical addresses, processor 30 references a flash translation layer (FTL) table 38 stored in translation table memory 34, depicted as a RAM buffer. FTL table 38 includes mapping for all possible LBAs to physical addresses of flash 26 so that, as wear leveling changes the physical address that is associated with an LBA, processor 30 is able to find information referenced by a host device. In a typical SSD, each GB of flash memory uses about 1 MB of translation table memory to map LBA to physical addresses. Thus, for example a 512 GB SSD will have a translation table memory size of 512 MB. In the example embodiment, translation table memory 34 is a DRAM buffer that provides rapid responses so that processor 30 can rapidly retrieve physical addresses for LBA requests. For example, a DRAM buffer is integrated in SSD controller 24 and dedicated to mapping LBA to physical addresses. In alternative embodiments, alternative types of memory may be used in alternative configurations for storing FTL table 38.

As is set forth in greater detail in U.S. patent application Ser. No. 15/273,573, incorporated herein as if fully set forth, in some predetermined conditions, copying less than all of FTL table 38 to translation table memory 34 provides adequate support for address translation. For example, a typical host device will span 8 GB for data locality during normal operations. By predicting the span of persistent memory needs and loading only the FTL table 38 used for the predicted span, less time is take to load the FTL table 38 data and less memory space is used.

For instance, using the above example numbers, a 512 MB translation table memory 34 will need only 8 MB of FTL table data to support operating system LBA requests, leaving 504 MB of unused memory. A 24 MB FTL table 38 provides a sufficiently high hit ratio to sustain IO operations with minimal impact of data throughput performance when unloaded FTL data has to be retrieved to respond to LBAs not supported in a partial FTL table load.

If less than all of FTL table 38 is loaded to translation table memory 34, then a cache manager 39 executing as embedded code on processor 30 takes advantage of unused translation table memory 34 to define a cache 40 of information retrieved from flash memory 26. Cache manager 39 retrieves information associated with selected of LBAs in the partial FTL table 38 load and stores the information in cache 40. As processor 30 receives LBA requests from the host device, cache manager 39 looks up the LBA in translation table memory 34 to determine if the information associated with the LBA is already stored in cache 40, and if so, responds to the host device request with the cached information. By responding from cache 40, processor 30 provides a more rapid response without having to look up the information in flash memory 26. If the LBA request is to write information to flash memory 26, then cache manager 39 commands a write of the updated information to cache 40 to keep cache 40 synchronized with flash memory 26.

Cache manager 39 selects information to cache based upon predictions of the information that the host device will most frequently request from flash memory 26. In some instances, the selected information adapts as functions on host device change. For example, particular LBA requests may relate to an application or set of data so that cache manager 39 refreshes cache 40 to prepare for anticipated LBA requests. For example, at host device startup, cache manager 39 loads information associated with LBAs that are called more frequently as start. As another example, at start of an application loaded at an LBA, cache manager 39 may load the LBA of the last document used by the application. In one example embodiment, cache manager 39 executes as embedded code save in the flash memory integrated in processor 30. In alternative embodiments, all or part of cache manager 39 may execute as instructions running with the host device operating system. For example, upon end user selection of a function, the operating system communicates a span of LBAs that processor 30 loads into cache 40.

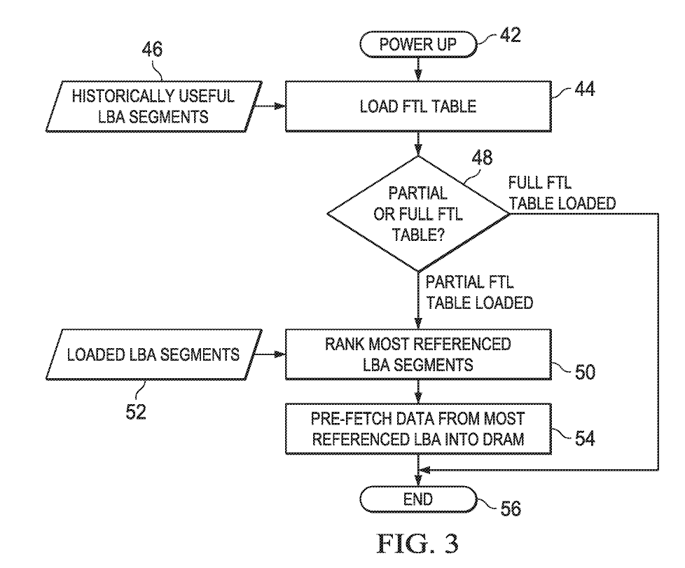

Referring now to FIG. 3, a flow diagram depicts a process for selectively caching information to a translation table memory. The process starts at step 42 with system power up and continues to step 44 to load the FTL table to the translation table memory, such as is set forth in U.S. patent application Ser. No. 15/273,573. For instance, the LBA to physical address mapping of historically useful LBA segments is loaded into the translation table memory with a partial or full FTL table load made as described by the factors in U.S. patent application Ser. No. 15/273,573. At step 48 a determination is made of whether a full or partial FTL table load was made to the translation table memory. If a full load of FTL table was made, the process ends at step 56 since unused translation table memory is not available for repurposing to cache memory functions. If a partial load of FTL table was made, the process continues to step 50 rank the most reference LBA segments from among the loaded LBA segments at step 52. At step 54, information for at least some of the most referenced LBA segments is pre-fetched from the persistent memory of the storage device and stored in the cache available in the DRAM of the translation table memory that is not used for storing the FTL table. Effectively, as FTL table information is partially loaded into translation table memory, translation table memory is repurposed to a quick response cache that has pre-fetched data ready for response to host device LBA requests.

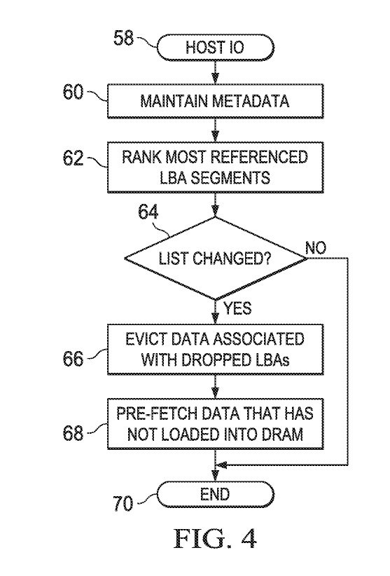

Referring now to FIG. 4, a flow diagram depicts a process for selecting information to cache to a translation table memory. The process starts at step 58 with initialization of a host IO and at step 60 with maintenance of metadata that tracks LBA requests, as described in U.S. patent application Ser. No. 15/273,573. At step 62, as host IO provides LBA requests, a rank is maintained of the most referenced LBA segments. In one embodiment, temporal management of the LBA requests adds currency as a factor for ranking LBA requests, such as by influencing rankings based how recent LBA requests were made. At step 64, a determination is made of whether the list of most reference LBA requests has changed. If not, the process ends at step 70. If the list has changed, the process continues to step 66 to evict data from the cache associated with LBAs that have dropped from the list and to step 68 to pre-fetch data that has moved up in rank to enter the cache.

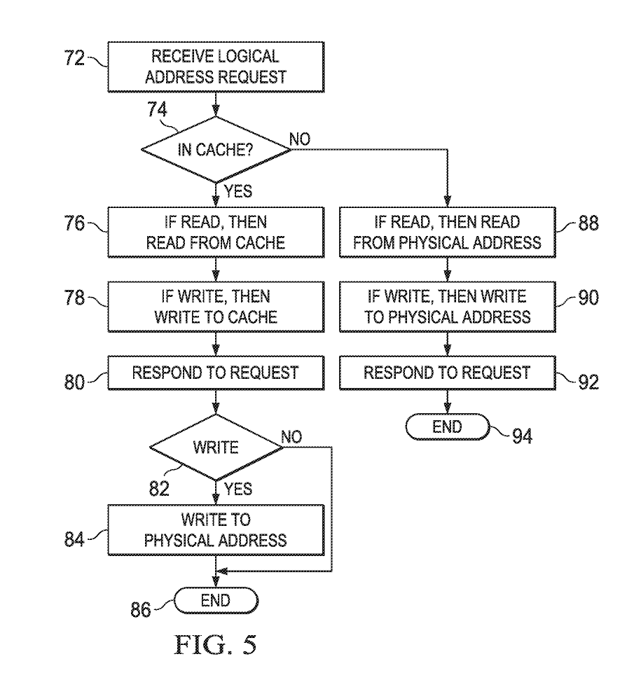

Referring now to FIG. 5, a flow diagram depicts a process for reading and writing information at a persistent storage device having translation table memory repurposed to cache stored information. At step 72, a logical address request is received from a host device, such as a logical block address from an operating system. At step 74, a determination is made of whether the information associated with the logical address is stored in the translation table memory. If the information is cached in the translation table memory, the process continues to step 76 to read the information from the cache if the logical address request is associated with a read command. At step 78, if the logical address request is associated with a write command, the information is written in the cache to update the cache so the cache maintains currency for subsequent reads to the logical address. At step 80, a response is provided to the request with reference to the cache read or write operation, thus providing a rapid response before completing any NAND operations. At step 82, a determination is made of whether the command associated with the logical address is a write command. If so, the process continues to step 84 to write the information to the physical address of the persistent storage device. The process ends at step 86.

If at step 74 the information is not in cache, the process continues to step 88. At step 88, if the request is to read information, then a read of the information is performed from a NAND physical address based upon a LBA to physical address translation. At step 90, if the request is a write, then a write is performed to a NAND physical address based upon a LBA to physical address translation. At step 92, the host IO interface responds to the logical address request and at step 94 the process ends.

Referring now to FIG. 6 an example of a flash translation layer table is depicted caching information for selected logical addresses. Essentially FTL table 38 is an index that maps logical addresses to physical addresses of the persistent memory. To promote effective and efficient cache responses, information associated with a logical address that is cached in translation table memory may be stored in the index. Alternatively, the FTL table may be broken into two separate portions, one with pre-fetched data and one without. As logical address requests arrive at the persistent storage device, a first look up in a first table would result in response with pre-fetched data, a second look up in second table would result in retrieval of the associated information from persistent storage, and a missing logical address would result in a miss that needs a FTL table data to find the physical address.

Although the present invention has been described in detail, it should be understood that various changes, substitutions and alterations can be made hereto without departing from the spirit and scope of the invention as defined by the appended claims.

1. An information handling system comprising:
a processor operable to execute instructions that process information;
a memory interfaced with the processor and operable to store the instructions and information;
a persistent storage device interfaced with the processor and having non-volatile memory having physical addresses, the non-volatile memory operable to store the instructions and information;
an operating system stored in the memory and executable by the processor to coordinate reads of information from the persistent storage device and writes of information to the persistent storage device, the reads and writes referenced to logical block addresses; and
a storage device controller interfaced with the persistent storage device and having a communication interface operable to receive reads and writes of logical block addresses from the operating system, having a processor operable to translate the logical block addresses to the physical addresses, and having first and second separate random access memories, the first random access memory having a translation table memory sized to store a translation table, the translation table mapping the logical block addresses to the physical addresses, the second random access memory having a cache that buffers information for transfer with the persistent storage device;
wherein the storage device controller processor selectively loads all or less than all of the translation table to the translation table memory based upon one or more predetermined conditions;
wherein, if less than all of the translation table is loaded to the translation table memory, the storage device controller retrieves information from the non-volatile memory for selected of the logical block addresses of the translation table loaded into the translation table memory and caches the retrieved information in the translation table memory; and
wherein if all of the translation table is loaded to the translation table memory, the storage controller does not cache information from the non-volatile memory in the translation table memory.

2. The system of claim 1 wherein:
the storage device controller responds to a read of a logical block address by determining if the information stored at the physical address associated with the logical block address is cached in the translation table memory;
if the information is cached, by responding to the read of the logical block address with the information cached in the translation table memory; and
if the information is not cached, by responding to the read of the logical block address with information stored in the non-volatile memory.

3. The system of claim 1 wherein:
the storage device controller responds to a write of a logical block address by determining if the information stored at the physical address associated with the logical block address is cached in the translation table memory; and
if the information is cached, by responding to the write of the logical block address by writing the information to the translation memory table.

4. The system of claim 1 wherein the translation table memory comprises random access memory integrated in the storage device controller.

5. The system of claim 4 wherein the persistent storage device non-volatile memory comprises flash memory.

6. The system of claim 5 wherein persistent storage device comprises a solid state drive and the non-volatile memory flash memory is NAND.

7. The system of claim 1 wherein the storage device controller processor monitors logical block address reads from the operating system to identify information to select in the non-volatile memory for caching in the translation table memory.

8. The system of claim 1 wherein the operating system monitors logical block address reads to identify information to select in the non-volatile memory for caching in the translation table memory.

9. The system of claim 1 wherein:
the storage device controller processor stores in the non-volatile memory at least some logical block addresses associated with information to cache in the translation table memory; and
upon power up of the persistent storage device, the storage device controller processor retrieves the information associated with the at least some logical block addresses from the non-volatile memory to the translation table memory.

10. A method for caching information stored in a persistent storage device, the method comprising:
selectively loading all or just a portion of a translation table into a translation table memory, the translation table mapping logical addresses received by a storage device controller to physical addresses of non-volatile memory integrated in the persistent storage device;
if just a portion of the translation table is loaded, then:
selecting some of the logical addresses of the portion of the translation table based upon a predetermined factor;
retrieving information stored in the non-volatile memory at the some of the logical addresses; and
caching the retrieved information in the translation table memory; and
if all of the translation table is loaded, use the translation table memory for the translation table and not caching information from the non-volatile memory.

11. The method of claim 10 further comprising:
receiving at the storage device controller a request for information stored at a logical address included in the some of the logical addresses; and
responding to the request with information cached in the translation table memory.

12. The method of claim 11 further comprising:
receiving at the storage device controller a request to write information to a logical address included in the some of the logical addresses; and
responding to the request in part by writing the information to the translation table memory.

13. The method of claim 10 further comprising:
monitoring at the storage device controller requests for information based on logical address; and
selecting the some of the logical addresses based in part on the number of requests for the logical addresses of the portion of the translation table.

14. The method of claim 10 further comprising:
predicting logical addresses that will be requested at the storage device controller; and
applying the predicted logical addresses as a predetermined factor.

15. The method of claim 10 wherein the non-volatile memory comprises flash memory and the translation table memory comprises random access memory integrated in the storage device controller.

16. The method of claim 15 wherein the translation table maps logical addresses used by an operating system to physical addresses of the flash memory.

17. A persistent storage device controller comprising:
a host interface operable to interact with a host with logical memory addresses communicated with the host device;
a non-volatile memory interface operable to interact with non-volatile memory with physical addresses of the non-volatile memory, the non-volatile memory providing persistent storage of information;
a first random access memory used as a translation table memory sized to store a translation table, the translation table mapping the logical memory addresses to the physical memory addresses;
a second random access memory used as a cache memory to buffer information transferred between the non-volatile memory and host interface;
a processor interfaced with the host interface, the non-volatile memory and the translation table, the processor operable to receive read requests to logical memory addresses from the host interface, to look up physical addresses for the logical addresses in the translation table, to retrieve information from the physical addresses in the non-volatile memory, and to provide the information to the host device; and
a cache manager operable to either use the translation table memory to store all of the translation table or to detect a predetermined condition and in response to the predetermined condition to load only part of the translation table into the translation table memory, the cache manager further operable to cache in the translation table memory at least some of the information stored in the non-volatile memory.

18. The persistent storage device controller of claim 17 wherein the cache manager is further operable to respond to host device logical memory address requests with the information cached in the translation table memory.

19. The persistent storage device controller of claim 18 wherein the translation table memory comprises random access memory, the non-volatile memory comprises flash memory, the cache manager comprises instructions stored in non-transitory memory of the processor, and the translation table tracks storage of information in the flash memory to wear level the flash memory.

20. The persistent storage device of claim 17 wherein the information cached in the translation table memory is selected based upon the number of references made by the host device to the logical addresses.
